(19) United States
(12) Patent Application Publication
(10) Pub. No.: US 2008/0191599 A1
(43) Pub. Date: Aug. 14, 2008

(54) DISCHARGE LAMP

(76) Inventors: Kenji Itaya, Osaka (JP); Yoshinori Kakuno, Osaka (JP); Kouichi Katase, Kyoto (JP); Jun'ichi Takahashi, Osaka (JP)

Correspondence Address: SNELL & WILMER L.L.P. (Matsushita), 600 ANTON BOULEVARD, SUITE 1400, COSTA MESA, CA, 92626, US

(21) Appl. No.: 12/028,716

(22) Filed: Feb. 8, 2008

(30) Foreign Application Priority Data
Feb. 13, 2007 (JP) 2007-032625

(51) Int. Cl. H01J 1/62

(52) U.S. Cl. 313/484

(57) ABSTRACT

The discharge lamp comprises: an arc tube including electrodes disposed at both ends of a glass tube; and bases provided at the two ends of the glass tube and supplying power to the electrodes. The arc tube includes two spiral parts, extending from the middle part of the glass tube to both end parts thereof, circularly winding around an imaginary axis and progressively away from the imaginary axis as shifted in a direction from the middle part toward the end parts. The end parts of the glass tube are attached by a silicon resin to adjacent parts of the glass tube, which are located on the imaginary axis side in relation to the end parts.

This application is based on application No. 2007-032625 filed in Japan, the contents of which are hereby incorporated by reference.

### BACKGROUND OF THE INVENTION

(1) Field of the Invention

The present invention relates to a discharge lamp including an arc tube in which (i) electrodes are disposed at both ends of a glass tube and (ii) a portion of the glass tube, extending from the middle part of the glass tube to at least one end part, or part before and adjoining to the end part, winds around an imaginary axis and progressively away from the imaginary axis as shifted in the direction from the middle part toward the at least one end part, or the part before and adjoining to the end part.

(2) Related Art

As a discharge lamp used for common lighting, circular tube discharge lamp is widely known which uses a circle-shaped arc tube formed by bending a straight bulb into a circular shape. With such circular tube discharge lamp, in recent years, there is an increasing demand for reduction in size.

This is because reducing the size of circular tube discharge lamps leads to a reduction in size of lamp fittings to which these circular tube discharge lamps are attached, space saving, and additionally resource saving.

Discharge lamps having a smaller arc tube than a conventional circle-shaped arc tube include, for example, one in which the central axis of a glass tube constituting an arc tube lies in the same single plane, the glass tube is formed into a shape winding around an imaginary axis and progressively away from the imaginary axis as shifted from the middle part of the glass tube toward both ends (the shape is called “flat double spiral”), and bases are provided at the end parts of the arc tube (e.g. Japanese Laid-Open Patent Application Publication No. H9-45283).

In such a flat double spiral arc tube, the glass tube is designed to fit in space corresponding to the inside space of a conventional circle-shaped arc tube, and consequently it is possible to make the maximum circular outer diameter of the arc tube smaller than that of a conventional circle-shaped arc tube.

However, with the arc tube of such a flat double spiral discharge lamp, there is a problem that the arc tube has a greater tendency to be broken during the discharge lamp being attached to or detached from a lamp fitting.

That is, in the case where the arc tube has a shape of a flat double spiral, the bases on the end parts of the arc tube are disposed symmetrically to each other with respect to the imaginary axis when the discharge lamp is viewed from the direction in which the imaginary axis lies (a so-called plan view).

When attaching and detaching the discharge lamp to/from a lamp fitting, users tend to hold portions of the glass tube, located at which an imaginary line perpendicular to the imaginary line connecting the two bases intersects with the outermost turn of the arc tube when the discharge lamp is viewed in a plan view (The portions correspond to, in FIG. 15, parts where attached members 73 and 75 are provided, and are referred to as the “gripping portions”.), because of their ease of holding. Thus, users, while holding the gripping portions, push the discharge lamp to a lamp fitting so that the bases are engaged with a socket of the lamp fitting, or pull the discharge lamp attached to a lamp fitting.

In these situations, too much force is applied to the glass tube and then the glass tube becomes broken.

### SUMMARY OF THE INVENTION

The present invention aims at offering a discharge lamp less likely to be broken when attached to and detached from a lamp fitting.

In order to realize the above object, the discharge lamp of the first present invention comprises: an arc tube (i) which includes a glass tube and electrodes each sealed in at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is; a holder supporting the arc tube; and two bases supplying power to the electrodes. Here, a 1^{st} region is within the portion of the glass tube. An adjacent part including one or more of the holder, the bases. A 2^{nd} region positioned within the glass tube is disposed adjacent to the 1^{st} region. The 1^{st} region is fixed to the adjacent part by a fixation material.

Here, the “portion of the glass tube, extending from a middle part of the glass tube to one of at least one end part and at least one end-part neighboring part” indicates part or all of said portion of the glass tube. That is, all the following cases are included: the case where partial or the entire glass tube, extending from the middle part to one end part, is wound; the case where partial or the entire glass tube, extending from the middle part to both end parts, is wound; the case where partial or the entire glass tube, extending from the middle part to one end-part adjacent part (i.e. a part of the glass tube, before and adjoining to the end part thereof), is wound; and the case where partial or the entire glass tube, extending from the middle part to both end-part adjacent parts, is wound.

The “holder” or “bases” may be integrally formed together (here, integrally molded ones are included), or they may be separately formed. The “adjacent part” only needs to be adjacent to said portion of the glass tube, and therefore it may be adjacent to the inner side of said portion of the glass tube (i.e. the side closer to the imaginary axis and in the direction perpendicular to the imaginary axis), or may be adjacent to the outer side of said portion of the glass tube (i.e. the side farther from the imaginary axis and in the direction perpendicular to the imaginary axis). Furthermore, the adjacent part may be adjacent to the lower side or upper side, in relation to the imaginary axis, of said portion of the glass tube. Also, multiple adjacent parts may be provided. For example, the adjacent parts may be provided on the outer and inner sides of said portion of the glass tube, and said portion may be fixed to both adjacent parts. It is a matter of course that the adjacent parts on the outer and inner sides of said portion of the glass tube may be the same member (e.g. the glass tube), or may be different members (e.g. the holder and the base).

In addition, being “fixed to the adjacent part by a fixation material” indicates, for example, the case of being attached to the adjacent part by an adhesive agent, such as a silicone resin or another resin adhesive, and the case of being fixed to the adjacent part by a fixation material, such as a hook (locking member).

According to the discharge lamp having the above structure, the 1^{st} region within said portion of the glass tube is fixed to the adjacent part which is adjacent to the 1^{st} region. Therefore, even if tensile load is applied to the discharge lamp when attached to and detached from a lamp fitting, deformation of the glass tube can be efficiently prevented. Consequently, it is possible to realize a discharge lamp less likely to be broken when attached to and detached from a lamp fitting.

Here, a tube central axis of the portion of the glass tube may lie in one plane.

Here, the region in which the “tube central axis of the portion lies in one plane” may be part or all of said portion of the glass tube.

Here, the adjacent part may include at least one of the 2^{nd} region and a portion of the bases.

In addition, the arc tube may have a disk-shaped outline, and one main surface of the arc tube may be an irradiating surface side. Here, the holder includes a platy member hanging across another main plane of the arc tube, opposite from the irradiating surface side. The bases are disposed on the platy member, and the adjacent part includes a portion of the platy member.

Furthermore, the fixation material may be an adhesive agent. Here, the 1^{st} region is the one end part of the glass tube, and the adjacent part is the portion of the bases.

Furthermore, the bases may oppose each other across the imaginary axis. Here, the 1^{st} region is part or all of a range between (i) each end of the discharge lamp and (ii) a location shifted by 45°, around the imaginary axis along the glass tube, toward the middle part from a substantially central portion of each of the bases when viewed in a plan view.

Furthermore, at least one of the bases may include a pair of pins both lying in one plane. Here, when viewed in a protruding direction of the pins, the plane lies at an angle of no greater than 45° against the imaginary axis.

Furthermore, the arc tube may have a shape of a double spiral.

On the other hand, in order to realize the above-mentioned object, the discharge lamp of the second present invention comprises: an arc tube (i) which includes a glass tube and electrodes each sealed in at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is; and two bases attached onto the end parts of the glass tube and supplying power to the electrodes. Here, adjacent parts within the glass tube, each of which is adjacent to one of the bases, are fixed at least to the bases by a fixation material.

According to the discharge lamp having the above structure, the adjacent parts within the glass tube, each of which is adjacent to one of the bases, are fixed at least to the bases by a fixation material). Therefore, even if tensile load is applied to the discharge lamp when attached to and detached from a lamp fitting, deformation of the glass tube can be efficiently prevented. Consequently, it is possible to realize a discharge lamp less likely to be broken when attached to and detached from a lamp fitting. On the other hand, in order to realize the above-mentioned object, the discharge lamp of the third present invention comprises: an arc tube (i) which includes a glass tube and electrodes each disposed at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is; and a holder supporting the arc tube. Here, adjacent parts within the glass tube, each of which is adjacent to one of the end parts of the glass tube, or one of end-part neighboring parts of the glass tube, are fixed to the end parts or the end-part neighboring parts by a fixation material.

According to the discharge lamp having the above structure, the adjacent parts within the glass tube, each of which is adjacent to one of end-part neighboring parts of the glass tube, are fixed to the end-part neighboring parts by a fixation material. Therefore, even if tensile load is applied to the discharge lamp when attached to and detached from a lamp fitting, deformation of the glass tube can be efficiently prevented. Consequently, it is possible to realize a discharge lamp less likely to be broken when attached to and detached from a lamp fitting.

### BRIEF DESCRIPTION OF THE DRAWINGS

These and other objects, advantages and features of the invention will become apparent from the following description thereof taken in conjunction with the accompanying drawings which illustrate a specific embodiments of the invention.

In the drawings:

FIG. 1 is a perspective view of a discharge lamp of an embodiment;

FIG. 2 is a plan view of the discharge lamp;

FIG. 3 is a bottom view of the discharge lamp;

FIG. 4 is an elevation view of the discharge lamp;

FIG. 5 is a lateral view of the discharge lamp;

FIG. 6 is a plan view of an arc tube with a partial cutaway to show internal details;

FIG. 7 is a perspective view of a holder;

FIG. 8 is an enlarged perspective view of a base;

FIG. 9 is a section view of the base of FIG. 8;

FIG. 10 shows an end part of the arc tube being inserted into the base, with a partial cutaway of the base to show internal details thereof;

FIG. 11 shows a cross section at E-E of FIG. 10 viewed from the direction of the arrow;

FIG. 12 shows a state after a silicon resin is filled;

FIG. 13 is a plan view of the arc tube, illustrating a method of manufacturing the discharge lamp;

FIG. 14 shows a cross section at E-E of FIG. 10 viewed from the direction of the arrow, illustrating the method of manufacturing the discharge lamp;

FIG. 15 is a schematic diagram of a tensile test of the discharge lamp;

FIG. 16 shows samples used in the tensile test and test results;

FIG. 17 is an elevation view of a discharge lamp of Modification 1, with a partial cutaway of an arc tube to show details of a base and its periphery in the arc tube;

FIG. 18 is an elevation view of a discharge lamp of Modification 2;

FIG. 19 is a plan view of a discharge lamp of Modification 3;

FIG. 20 shows a base of Modification 4;

FIG. 21 shows a base of Modification 5;

FIG. 22 is a plan view of a discharge lamp of Modification 6; and

FIG. 23 shows part of a discharge lamp of Modification 7.

### DESCRIPTION OF PREFERRED EMBODIMENTS

The following describes a preferred embodiment of a discharge lamp according to the present invention with reference to drawings.

1. Structures of Discharge Lamp

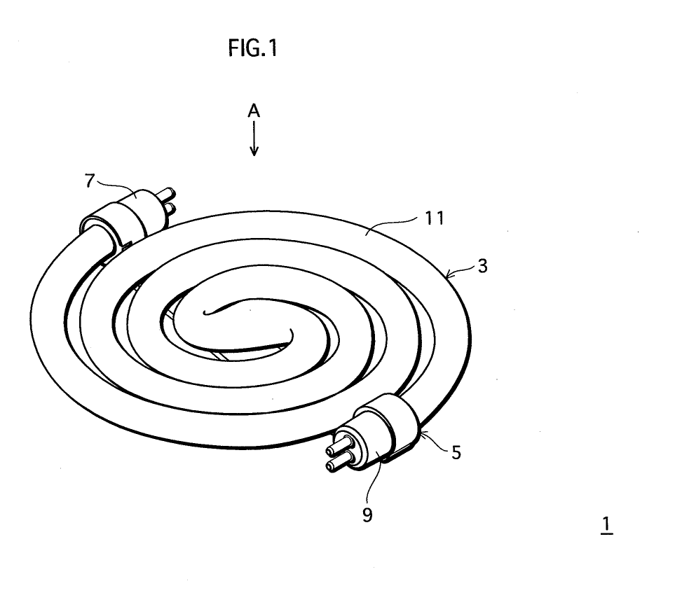

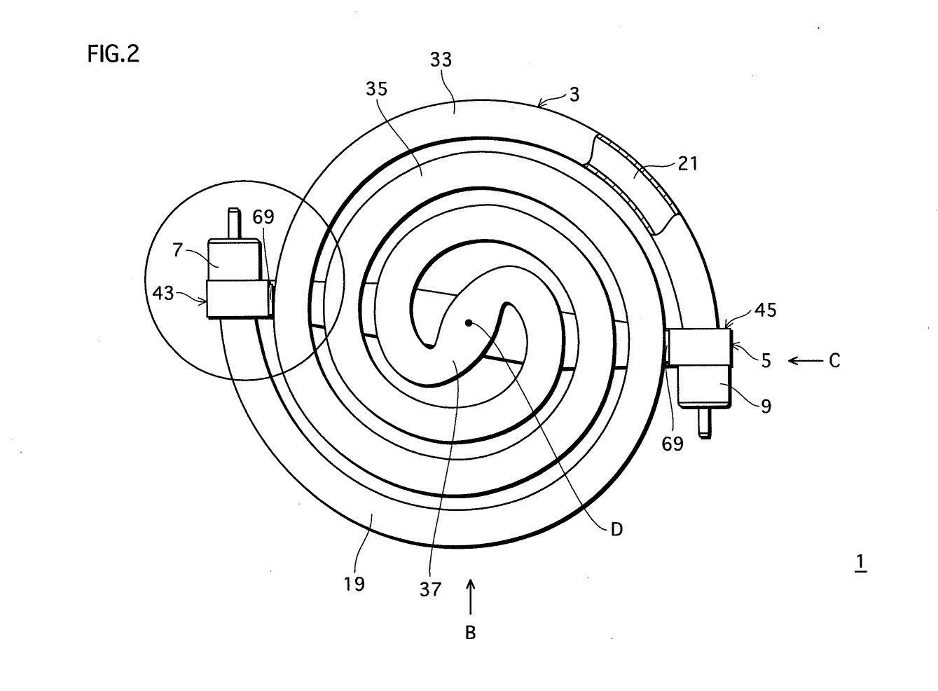

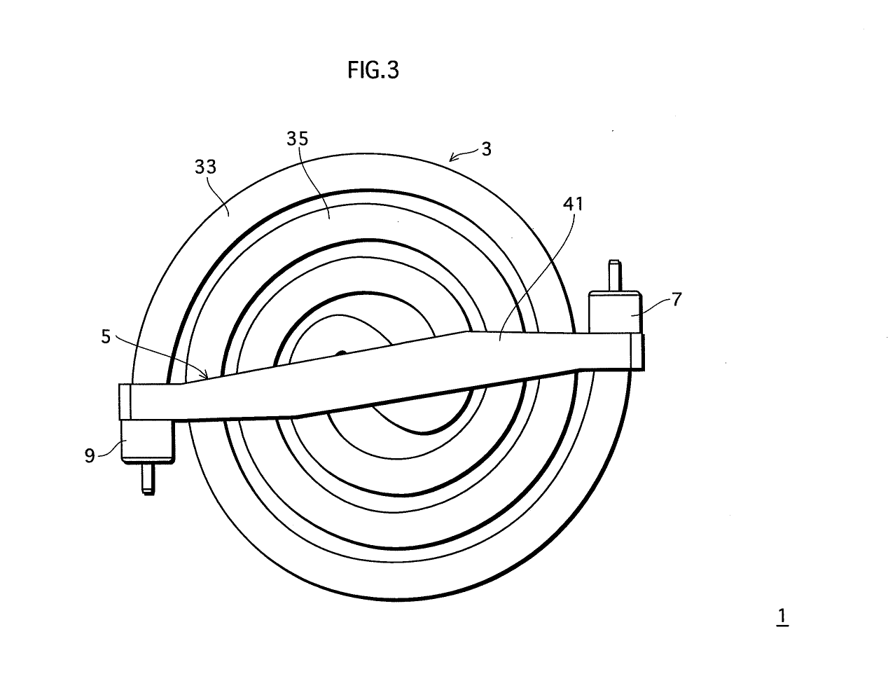

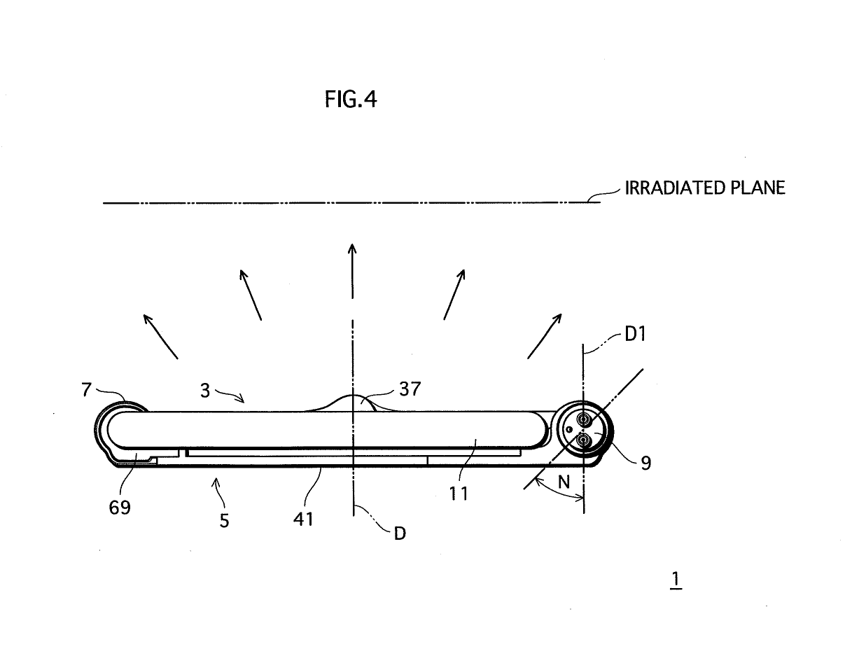

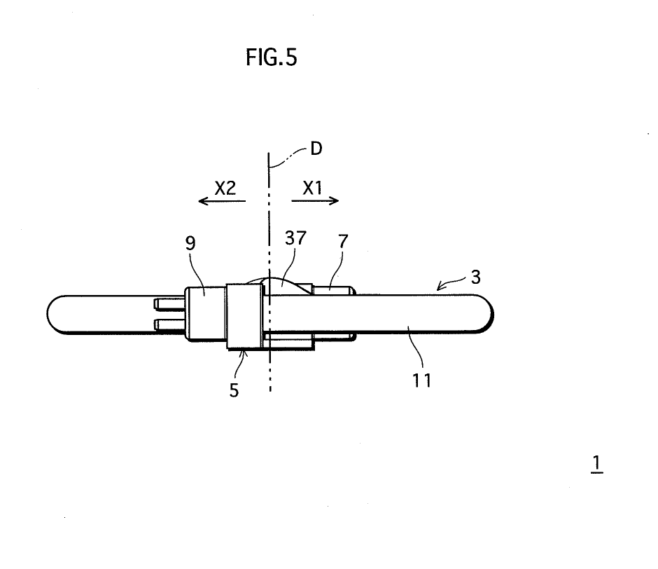

FIG. 1 is a perspective view of a discharge lamp of the embodiment. FIGS. 2 and 3 are a plan view and a bottom view, respectively, of the discharge lamp. FIGS. 4 and 5 are an elevation view and a lateral view, respectively, of the discharge lamp.

Here, the plan view of a discharge lamp 1 (FIG. 2) is a diagram where the discharge lamp 1 fitted to a lamp fitting is viewed from an irradiated plane (see FIG. 4). That is, the diagram provides a view of the discharge lamp 1 seen from the upper side in FIG. 1 (Direction A in the figure). The elevation view of the discharge lamp 1 (FIG. 4) is a diagram of the discharge lamp 1 viewed from the lower side in FIG. 2 (Direction B in the figure); the lateral view of the discharge lamp 1 (FIG. 5) is a diagram of the discharge lamp 1 viewed from the lateral side in FIG. 2 (Direction C in the figure). Note that the side of the discharge lamp 1 facing the irradiated plane is also referred to as an irradiating plane side.

The discharge lamp 1 includes, as shown in FIGS. 1-5: an arc tube 3 having a single discharge path therein; and a holder 5 holding the arc tube 3. With the holder 5 to be hereinafter described, bases 7 and 9 are attached thereto to supply power to electrodes provided on both ends of a discharge space in the arc tube 3.

(1) Arc Tube

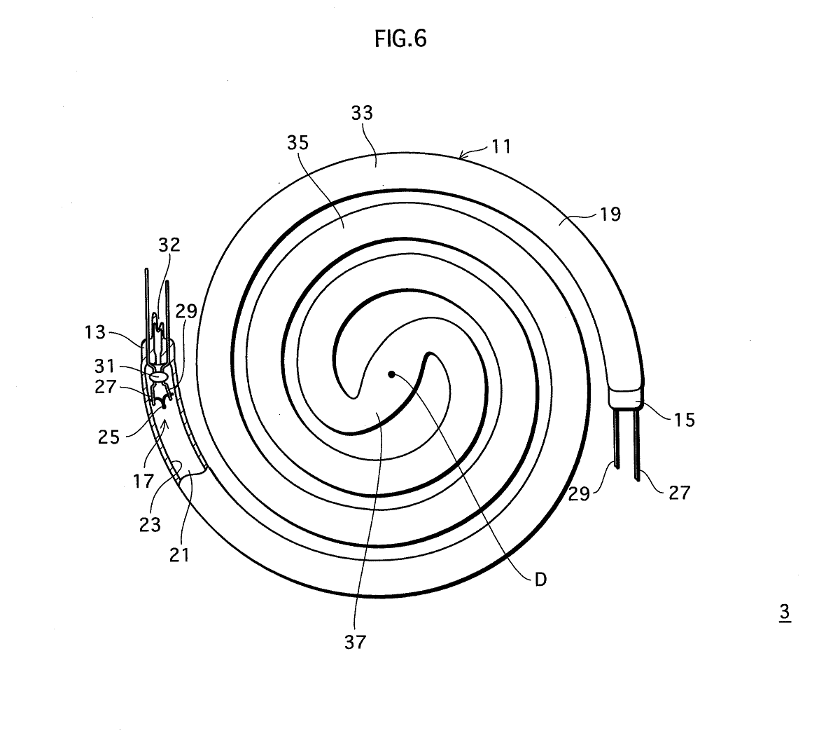

FIG. 6 is a plan view of the arc tube, with a partial cutaway to show internal details.

As shown in FIGS. 1-6, especially in FIG. 6, the arc tube 3 includes an arc-tube main body 11 and electrodes 17 and 17 sealed in at both end parts 13 and 15 of the arc-tube main body 11. The arc-tube main body 11 is formed by, for example, winding a glass tube into a flat double spiral so as to have a substantially disk-shaped outline as a whole.

Note that the end parts 13 and 15 of the arc-tube main body 11 correspond to end parts of a glass tube 19 constituting the arc-tube main body 11 (therefore, the reference numerals “13” and “15” are used for the end parts of the glass tube 19), and they also correspond to end parts of a discharge path 21 formed inside the arc tube 3.

Although, in FIG. 6, an electrode at the end part 15 of the arc-tube main body 11 is omitted for convenience of illustration, an electrode having the same structure as the electrode 17 is sealed in at this end part 15.

Inside the arc-tube main body 11, mercury (e.g. 5 mg) and a mixed gas (e.g. the ratio of argon gas to neon gas is 75:25, the charged pressure is 400 Pa) acting as a buffer gas are enclosed.

Note that the amounts of the mercury and mixed gas above are merely examples, and the mixing ratio of the argon gas and neon gas constituting the buffer gas is not limited to the above. In addition, the buffer gas may be formed by a pure argon gas or a pure xenon gas.

Furthermore, the mercury sealed in the arc-tube main body 11 may be elemental mercury, or may be amalgam mercury such as zinc-mercury, tin-mercury, or bismuth-indium-mercury. That is, the constitution of the mercury is not particularly limited, and any constitution can be employed as long as, when the discharge lamp 1 is lit, the vapor pressure of the mercury in the arc tube 3 exhibits substantially the same characteristics as when elementary mercury is used.

On the inner surface of the arc-tube main body 11, for example, a phosphor layer 23 is formed, as shown in FIG. 6. The phosphor layer 23 is formed by baking, for example, rare-earth phosphors. The phosphors used here are three types respectively emitting red, green, and blue light, and include Y₂O₃:Eu, LaPO₄:Ce and Tb, and BaMg₂Al₁₆O₂₇:Eu and Mn, for instance.

The electrode 17 is formed by using so-called a bead mounting method, as shown in FIG. 6, and includes a tungsten filament coil 25, a pair of lead wires 27 and 29 supporting the filament coil 25 therebetween in a manner that the filament coil 25 hangs across the paired lead wires 27 and 29, and a bead glass 31 fixing and supporting the paired lead wires 27 and 29.

Each of the end parts 13 and 15 of the arc-tube main body 11 is flattened by being pinch-sealed with the filament coil 25 of the electrode 17 being inserted and disposed at a predetermined position inside the arc-tube main body 11. Herewith, the electrodes 17 and 17 are fixed to the arc-tube main body 11. Note that the end parts 13 and 15 of the arc-tube main body 11 are pinched in a direction perpendicular to the page of FIG. 6.

Within the electrode 17, it is part of the lead wires 27 and 29 that is fixed at each end part 13/15 of the arc-tube main body 11. More specifically speaking, it is part of the lead wires 27 and 29, extending on the opposite side from the filament coil 25 in relation to the bead glass 31.

At one end part (here, the end part 13) of the arc-tube main body 11, an outlet tube 32 is fixed together with the electrode 17. The outlet tube 32 is used to form a vacuum inside the arc-tube main body 11 and feed in a buffer gas therefrom to the inside of the arc-tube main body 11 after the electrode 17 and the like are fixed.

The arc-tube main body 11 includes: two spiral parts 33 and 35, for example, circularly winding around an imaginary axis D (see FIGS. 4-6) to be hereinafter described; and a middle part 37 positioned between the spiral parts 33 and 35 and connecting them.

The central axis of the glass tube 19 constituting the spiral parts 33 and 35 lies in a plane substantially perpendicular to the imaginary axis D. And, from the middle part 37 side toward the end part 13/15 sides, the spiral parts 33 and 35 are wound away from the imaginary axis D. Note that the direction in which the imaginary axis D lies is also referred to as an imaginary axis direction.

A section of the arc-tube main body 11, through which the imaginary axis D passes—i.e. the section including a substantially central portion of the middle part 37, bulges toward the irradiated plane in the imaginary axis direction (on the opposite side from the holder 5 in relation to the arc tube 3), as shown in FIGS. 4 and 5. The coldest spot is formed at the bulging portion during the period when the lamp is lit.

For the glass tube 19, for example, barium strontium silicate glass (lead-free and soft glass) is used, and the glass tube 19 is, for example, substantially round in cross section.

Note however that the cross sectional shape of the glass tube 19 is not limited to round, and may be substantially elliptic or polygon-shaped, for example. However, the glass tube after being formed into the arc-tube main body 11 has not a perfect round but a slightly deformed shape in cross section since it is formed by bending a softened single glass tube.

When the arc-tube main body 11 is viewed from the irradiated plane side as shown in FIG. 6, there are gaps between portions of the spiral parts 33 and 35, where the spiral parts 33 and 35 come closest to each other in directions perpendicular to the imaginary axis D (hereinafter, referred to as “radial directions” which are shown by the arrows X1 and X2 in FIG. 5). Note that gaps between the spiral parts 33 and 35 can be constant, or may become progressively or gradually larger, or smaller, in the direction away from the middle part 37.

The arc tube 3 here is a complete form made by forming the phosphor layer 23 on the internal surface of the arc-tube main body 11, then attaching the electrodes 17 and 17 and enclosing a buffer gas and the like in the arc-tube main body 11. In the following where explanations are given using the “arc tube 3”, the same reference numerals as the end parts 13 and 15 of the arc-tube main body 11 and the middle part 37 are used to indicate corresponding parts of the arc tube 3 (i.e. denoted as “end parts 13 and 15” and “middle part 37” of the arc tube 3). In addition, the radial direction and imaginary axis D of the arc-tube main body 11 are also used in the explanations of the arc tube 3, denoted as the radial direction and imaginary axis D of the arc tube 3.

Note that an “end of the glass tube 19” indicates one before being pinch-sealed; an “end of the discharge lamp 1” indicates an end of the base 7/9 (i.e. corresponding to the tip of a pin).

(2) Holder

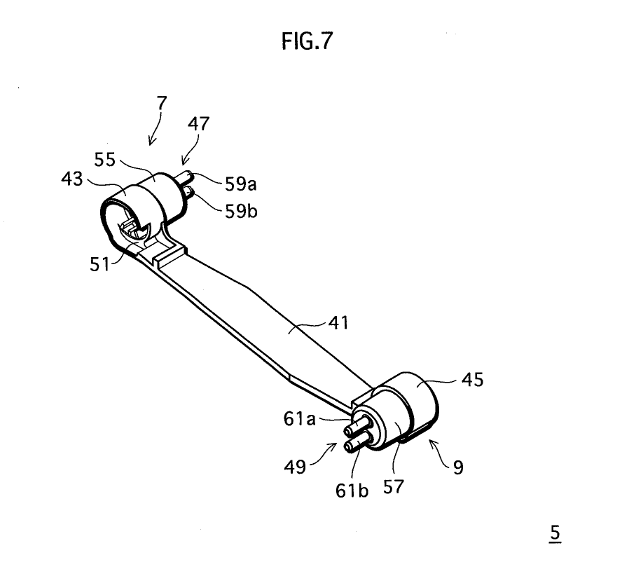

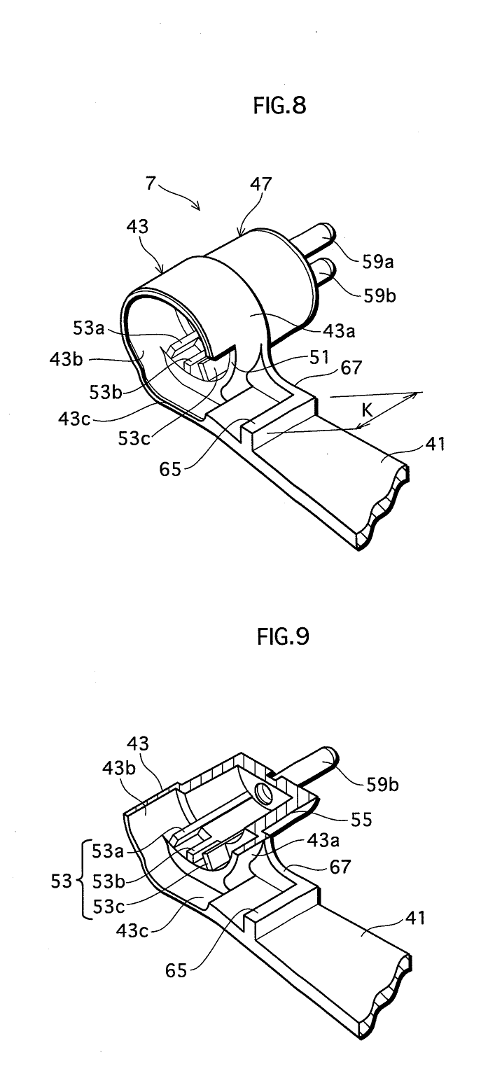

FIG. 7 is a perspective view of a holder; FIG. 8 is an enlarged perspective view of the base 7; and FIG. 9 is a section view of the base 7 of FIG. 8.

As shown in FIG. 7, the holder 5 has a structure in which two bases 7 and 9 are provided at both ends of a single platy member 41, which spans an opposite plane side, from the irradiating plane side, of the arc tube 3 having a substantially disk-shaped outline as a whole.

Here, the platy member 41 and bases 7 and 9 are integrally formed together; however, the platy member and bases may be separately manufactured, and subsequently combined into a single form. That is, the holder may or may not include bases.

The base 7/9 includes, as shown in FIGS. 2 and 7, a fitting part 43/45 fitted onto the end part 13/15 of the arc tube 3 and a base part 47/49 electrically connected to a socket (not sown) of a lamp fitting to receive power.

The fitting part 43/45 has, as shown in FIG. 7, such a substantially cylindrical form that creates a gap with the circumference of the end part 13/15 of the arc tube 3. The fitting parts 43 and 45 are provided on the platy member 41 in a manner that their openings face away from each other.

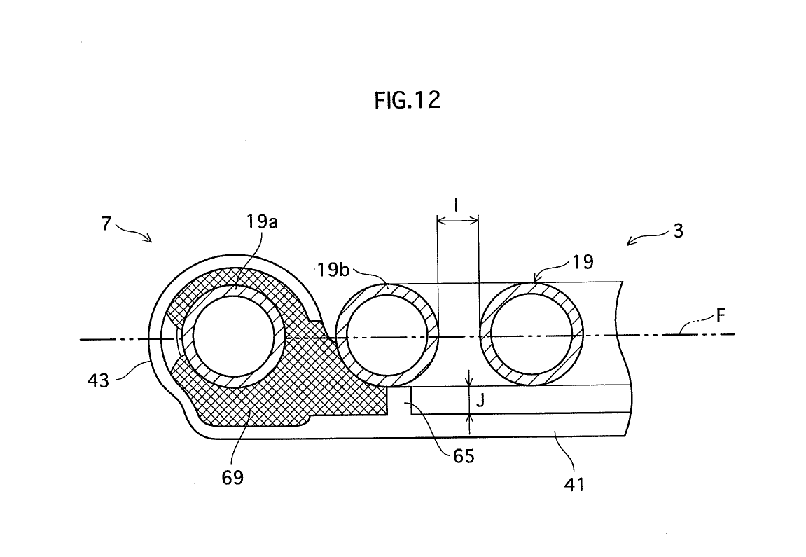

Regarding the appearance configuration of the fitting part 43/45, when viewed from a direction in which the central axis of the cylindrical fitting part 43 lies (also referred to as the “fitting-part central axis direction”) (see FIG. 12), a portion of the fitting part 43/45 away from the irradiated plane (i.e. a lower portion of the fitting part 43/45) in the imaginary axis direction protrudes and jutted out towards the side away from the irradiated plane (i.e. the lower side). The protruding portion of the fitting part 43/45 and the platy member 41 are connected to each other in a manner that their connected surface away from the arc tube 3 (i.e. the lower sides of the fitting part 43 and the platy member 41 shown in FIG. 12) becomes substantially flush (here, the connecting portion is referred to as a connecting portion 43c).

These fitting parts 43 and 45 have the same structure although having their openings oppositely disposed; the following describes the fitting part 43 in detail.

The fitting part 43 includes a 1^{st} cylinder part 43a and a 2^{nd} cylinder part 43b, as shown in FIGS. 8 and 9. The 1^{st} cylinder part 43a has an internal circumference which is slightly larger than the outer circumference of the end part 13 of the arc tube 3. The 2^{nd} cylinder part 43b has the same internal circumference as the 1^{st} cylinder part 43a, and includes a portion corresponding to the connecting portion 43c protruding toward the opposite side from the irradiated plane. The 2^{nd} cylinder part 43b is disposed on the opening side of the fitting part 43. Therefore, there is a step at the boundary between the 1^{st} and 2^{nd} cylinder parts 43a and 43b

In the fitting part 43, a guiding part is formed to guide, when the base 7 and the arc tube 3 are attached to each other by a fixation material—e.g. an adhesive agent, such as a silicon resin, excess agent after filled in the base 7 toward part of the glass tube adjacent to the base 7 in radial directions (the part of the glass tube is referred to as a “base adjacent part”).

Here, the base 7 is attached to the end part 13 of the arc tube 3. The base adjacent part corresponds to the “1^{st} region” of the first present invention, to the “adjacent parts” of the second present invention, and to the “adjacent parts” of the third present invention.

The guiding part is here a notched part 51, and formed, within the fitting part 43, in a region extending from the connecting portion 43c to a point shifted toward the irradiated plane side from the connecting portion 43c by substantially the radius of the glass tube 19.

Here, the sizes of the 1^{st} cylinder part 43a and the 2^{nd} cylinder part 43b in the central axis direction of the fitting part 43 are substantially the same, and the notched part 51 is formed on the 2^{nd} cylinder part 43b; however, these sizes may be different. The 1^{st} cylinder part 43a and 2^{nd} cylinder part 43b have different inner circumference shapes; however, they could have the same shape.

The base part 47/49 is provided on the other side of the opening of the fitting part 43/45.

The base part 47/49 is a so-called G-type (e.g. G5 type), including: a cylindrical base-part main body 55/57 having a bottom; and a pair of pins 59a and 59b/61a and 61b provided at the bottom wall surface of the base-part main body 55/57, as shown in FIGS. 7-9.

The paired pins 59a and 59b of the base part 47 and the paired pins 61a and 61b of the base part 49 protrude in spiraling directions of the spiral parts 33 and 35 of the arc tube 3 (the spiraling directions are also referred to as the “circumferential direction”) and in the opposite directions from each other. One of the paired pins 59a/61a is substantially parallel to the other 59b/61b in the imaginary axis direction, as shown in FIG. 2.

The protruding direction of the paired pins 59a and 59b/61a and 61b is substantially parallel to the plane in which the central axis of the glass tube 19 of the two spiral parts 33 and 35 structuring a flat double spiral lies (i.e. the plane in which an imaginary line F of FIG. 12 lies and which is perpendicular to the page of the figure). In other words, the paired pins 59a and 59b/61a and 61b protrude in a linear manner in the circumferential direction of the two spiral parts 33 and 35.

Inside the base 7/9, a restraint part is formed to position the end part 13/15 of the arc tube 3 and restrain a shift (move) of the end part 13/15. Here, the bases 7 and 9 have the same structure, and therefore the following describes mainly the restraint part of the base 7 with the aid of FIGS. 8 and 9.

The restraint part is provided inside the base 7, for example, on the internal circumference of the base part 47 and fitting part 43 (here, the 1^{st} cylinder part 43a). Here, multiple ribs 53 are given as an example of such a restraint part. The multiple ribs 53 protrude toward the central axis of the fitting part 43 and extend along the central axis direction of the fitting part 43 (i.e. the direction in which the end part 13 of the arc tube 3 is inserted).

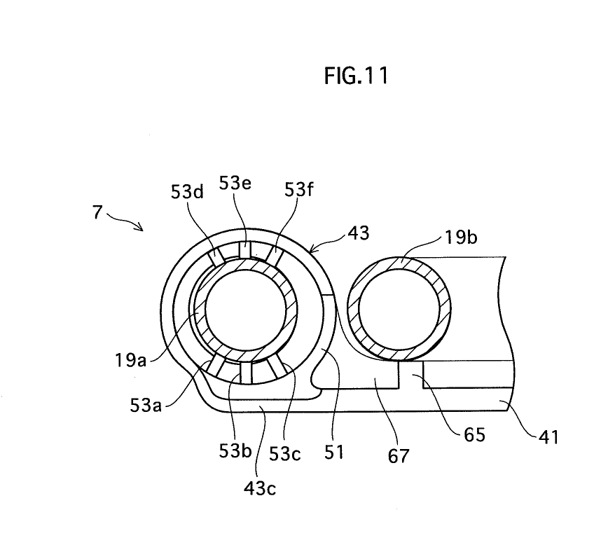

The multiple ribs 53 includes six ribs in total, as shown in FIG. 11—three (53a, 53b and 53c) at a region shifted from the center of the fitting part 43 toward the connecting portion 43c and three (53e, 53f and 53g) at a region shifted from the center toward the irradiated plane.

Here, the total number of ribs 53 is six; however, the number is not limited to this if the ribs are able to roughly set the position of the end of the arc tube. Note however that, in the case where an arc tube having a circular cross section is used, providing three or more ribs would facilitate to position the end of the arc tube.

The platy member 41 has, as shown in FIG. 7, a shape of a rectangular plate (a rectangle in a plan view), and has the bases 7 and 9 at both ends thereof in the longitudinal direction.

On the platy member 41, a supporting projection 65 is formed to support the arc tube 3. The supporting projection 65 is, as shown in FIG. 11, provided at a position to support (i.e. abut on) a base adjacent part 19b from the platy member 41 side.

The supporting projection 65 is formed, as shown in FIGS. 8 and 9, to span between both edges, in the width-wide direction, of the platy member 41. In addition, a connecting projection 67 is formed at the end of the platy member 41 (i.e. the end of the base part side) where the end part of the arc tube 3 is inserted. The connecting projection 67 projects from the platy member 41 on the irradiated plane side and extends along an edge of the platy member 41, connecting to one end of the supporting projection 65.

(3) Attaching Structure of Arc Tube and Holder

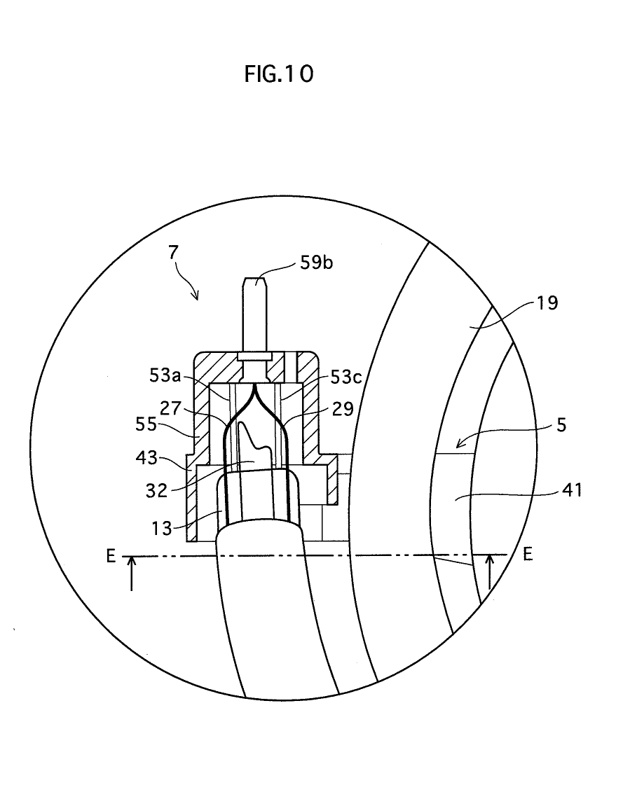

FIG. 10 shows a state where the end part 13 of the arc tube 3 is inserted into the base 7, with a partial cutaway of the base 7 to show internal details thereof. FIG. 11 shows a cross section at E-E of FIG. 10, viewed from the direction of the arrow.

In the state where the end part 13 of the arc tube 3 is inserted into the base 7, the outer circumference of a glass-tube portion in the end part 13 of the arc tube 3 (the glass-tube portion is referred to as the “glass-tube end portion 19a”) is supported by the ribs 53 formed on the fitting part 43 and the base-part main body 55, as shown in FIG. 11. Also, the outer circumference of the base adjacent part 19b of the arc tube 3 is supported by the supporting projection 65.

The paired lead wires 27 and 29 extending from the end part 13 of the arc tube 3 are, as shown in FIG. 10, go through the inside of the pin 59b provided on the bottom of the base-part main body 55 and are attached at the tip of the pin 59b by soldering or the like. Note that, in FIG. 10, the pin 59b is not shown as a cross section.

The attachment of the arc tube 3 to the bases 7 and 9, to be hereinafter described, is realized by a fixation material—e.g. an adhesive agent, for example a resin adhesive such as a silicon resin (69) as shown in FIG. 12—filled between the base 7 and the end part 13 of the arc tube 3.

FIG. 12 shows a state after a silicon resin is filled.

As shown in FIG. 12, the silicon resin 69 is filled in the gap between the base 7 and the glass-tube end portion 19a of the arc tube 3 inserted inside the base 7 (see FIGS. 10 and 11), and also filled between the glass-tube end portion 19a and the base adjacent part 19b of the arc tube 3. Herewith, the base 7 and the glass-tube end portion 19a of the end part 13 of the arc tube 3 are attached to each other (see FIG. 12). And the base adjacent part 19b of the arc tube 3 is attached by the silicon resin 69 to the 1^{st} cylinder part 43a of the fitting part 43 of the base 7, the glass-tube end portion 19a of the arc tube 3 via the notched part 51 of the fitting part 43 of the base 7, and the platy member 41. Note that the base 7, glass tube 19 and holder 5 (platy member 41) correspond to the “adjacent part” of the first present invention. The base 7 corresponds to one of the “bases” of the second present invention. Furthermore, the base 7, glass tube 19 and holder 5 (platy member 41) correspond to the “end parts” or the “end-part neighboring parts” of the third present invention.

The region where the base adjacent part 19b of the arc tube 3 is attached by the silicon resin 69 is located on the platy member 41 side in relation to the imaginary line F which is formed by connecting the axial center of the glass tube 19 (19a and 19b) constituting the spiral parts 33 and 35. This is because if the silicon resin 69 is present on the irradiated plane side in relation to the imaginary line F, light is not emitted from the part to which the silicon resin is on, resulting in a reduction of luminous flux.

2. Method of Manufacturing Discharge Lamp

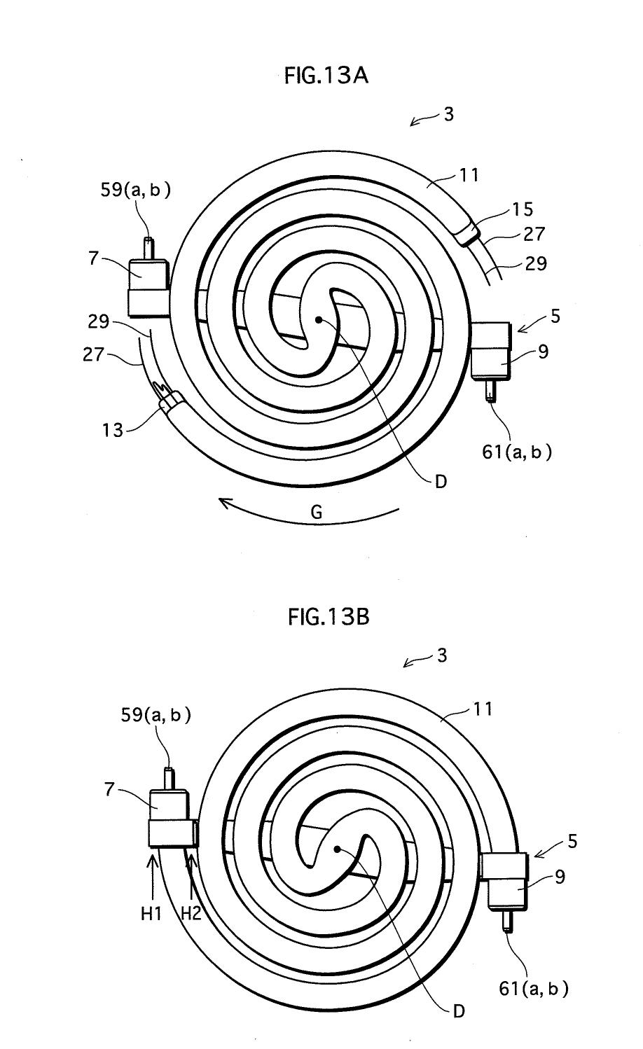

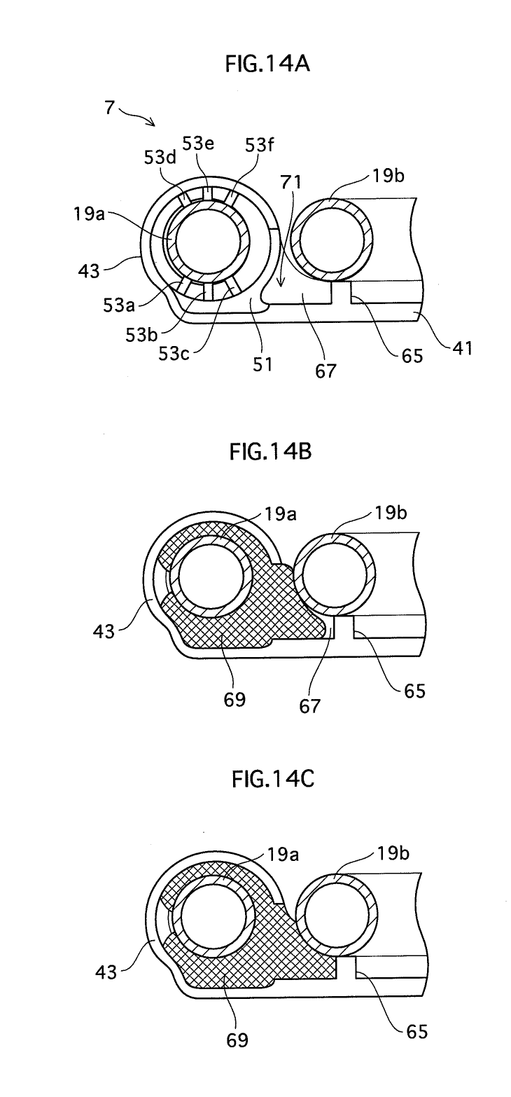

FIGS. 13 and 14 provide plan views of the arc tube and are drawings for illustrating the method of manufacturing the discharge lamp, especially for explaining the process of attaching the arc tube 3 and the holder 5. Note that FIG. 14 shows a cross section at E-E of FIG. 10, viewed from the direction of the arrow.

Manufacturing of the discharge lamp 1 includes a manufacturing process of the arc tube 3, a manufacturing process of the holder 5, and an attaching process of the arc tube 3 and the holder 5 (referred to as the “attaching process”).

The attaching process mainly includes: a fitting process in which the bases 7 and 9 are fitted onto the end parts 13 and 15 of the arc tube 3 (referred to as the “fitted state”); a resin filling process in which, while the bases 7 and 9 remain fitted onto the end parts 13 and 15, a silicon resin (adhesive agent) is filled into the space, within the bases 7 and 9, created between the bases 7 and 9 and the end parts 13 and 15 of the arc tube 3, and the silicon resin inside the bases 7 and 9 is drained to the base adjacent part 19b side of the arc tube 3 via the notched part 51; and a hardening process to harden the filled silicon resin.

The attaching process is described below.

First, as shown in FIG. 13A, the arc tube 3 and the holder 5 are prepared and positioned to be set in a predetermined state.

Here, the predetermined state is a state (i) maintaining a positional relationship which allows the end parts 13 and 15 of the arc tube 3 to be inserted into the bases 7 and 9 through the openings thereof when the arc tube 3 is rotated in a direction G around the imaginary axis D as shown in FIG. 13A, and (ii) having the end parts 13 and 15 of the arc tube 3 outside the bases 7 and 9. Note that the holder 5 may be rotated around the imaginary axis D in the opposite direction of the direction G while the arc tube 3 is being fixed, or both the arc tube 3 and the holder 5 may be rotated.

Once the arc tube 3 and the holder 5 are positioned to be set in the predetermined state, the arc tube 3 is rotated in the direction G around the imaginary axis D so that the end parts 13 and 15 of the arc tube 3 are inserted into the bases 7 and 9 (fitting parts) (this state is the “fitted state” above, and the process is the “fitting process”).

At this point, since multiple ribs 53a-53f are formed on the internal surface of the base 7, it is possible to position the arc tube 3 to set in a certain state and to maintain the glass-tube end portion 19a of the arc tube 3 in the substantial center of the base 7.

Then, while maintaining the fitted state with keeping the positional relationship of the arc tube 3 and the bases 7 and 9 as it stands, the silicon resin 69 (adhesive agent) is filled into the bases 7 and 9, that is, between the glass-tube end portion 19a of the arc tube 3 and the internal surfaces of the bases 7 and 9. The silicon resin 69 is filled from two points of H1 and H2 as shown in FIG. 13B.

Here, since the glass-tube end portion 19a of the arc tube 3 is held in a manner to form a predetermined gap with the internal surface of the base 7, the silicon resin 69 is readily filled between the base 7 and the glass-tube end portion 19a, whereby enhancing the attaching strength of the base 7 and the arc tube 3. In addition, because of the gap between the glass-tube end portion 19a and the internal surface of the base 7, the silicon resin 69 filled in the base 7 readily flows between the glass-tube end portion 19a and the internal surface of the base 7, which facilitates filling of the silicon resin 69 into the base 7.

When the silicon resin 69 continues to be being filled, the silicon resin 69 inside the base 7 passes through the notched part 51 of the fitting part 43 to flow out toward the base adjacent part 19b.

Since the notched part 51 is formed on the base 7, the silicon resin 69 flowed out from the inside of the base 7 as more silicon resin 69 is sent into the base 7 flows toward the base adjacent part 19b from the notched part 51, whereby preventing the silicon resin 69 from flowing out to other part of the base 7.

Then, when the space (shown by “71” of FIG. 14A) formed by the base adjacent part 19b of the arc tube 3, the platy member 41, the supporting projection 65 and the connecting projection 67 is filled by the silicon resin 69 as shown in FIG. 14C, filling of the silicon resin 69 is stopped (the start to stop of the filling of the silicon resin 69 is the resin filling process).

Because the supporting projection 65 and the connecting projection 67 are provided on the platy member 41 in a protruding condition, the silicon resin 69 flowed out from the inside of the base 7 is blocked by the supporting projection 65 and the connecting projection 67 and reaches the base adjacent part 19b held by the supporting projection 65.

Herewith, the platy member 41, the base 7a nd the base adjacent part 19b are attached to each other in a reliable manner. In addition, it is possible to prevent the silicon resin 69 from flowing out to other part of the platy member 41 by the supporting projection 65 and the connecting projection 67.

Lastly, the filled silicon resin 69 is hardened (hardening process), and then the manufacturing of the discharge lamp 1, as shown in FIGS. 1 and 12, is completed.

Note that the descriptions of some of processes taking place in the manufacturing are omitted here, such as a process of removing silicon resin overflowed from the bases 7 and 9 after the silicon resin 69 is filled in or hardened.

Herewith, the attachment of the base 7 (including the glass-tube end portion 19a) to the base adjacent part 19b can be performed nearly simultaneously in the attaching process of the arc tube 3 and the base 7. This enhances the manufacturing efficiency of the discharge lamp and it is possible to realize the present invention at moderate costs.

In addition, because the notched part 51 is formed on the base 7, when the silicon resin 69 fed into the gaps between the end parts 13 and 15 of the arc tube 3 and the bases 7 and 9 is overflowed from the gaps, the overflowed silicon resin can be guided toward the adjacent glass tube through the notched part 51 in a reliable manner.

Furthermore, the silicon resin 69 overflowed from the notched part 51 of the fitting parts 43 and 45 flows toward the base adjacent part 19b along the platy member 41, and is consequently blocked by the connecting projection 67, the supporting projection 65 holding the arc tube 3, and the like to fill the gap between the base 7 and the base adjacent part 19b. Accordingly, the base 7, the platy member 41 and the base adjacent part 19b can be reliably attached to each other by the silicon resin 69.

3. Practical Example

The following explains a specific structure of the discharge lamp of the embodiment.

The input power of the discharge lamp 1 is set at 20 W, and in this state, the luminous flux emitted from the discharge lamp 1 is 1800 lm.

The glass tube 19 used for the arc tube 3 has an outer diameter of 9.0 mm and an inner diameter of 7.2 mm. The arc tube 3, with two spiral parts 33 and 35 together, has approximately 3.5 turns spiraling around the imaginary axis D.

The arc tube 3 has a length of 120 mm in the direction connecting the end parts 13 and 15 and a length of 110 mm in the direction perpendicular to the connecting direction.

The gap between parts of the glass tubes 19, which are adjacent to each other in the radial directions (this is also a gap between the spiral parts 33 and 35, and indicated by “I” in FIG. 12), is approximately 2.0 mm, and the height of the arc tube 3 is 10 mm to 11 mm.

The gap I between the adjacent spiral parts 33 and 35 becomes smallest on the imaginary line connecting the central axes of the spiral parts 33 and 35 in the cross section since the glass tube 19 constituting the spiral parts 33 and 35 has a circular cross section. If the gap I between the adjacent spiral parts 33 and 35 is set in the range of 1 mm and 6 mm, it is possible to enhance the efficiency of light extraction while maintaining the compactness of the arc tube 3 in the radial directions.

The entire length of the glass tube 19 is 740 mm and the distance between the electrodes inside the arc tube 3 is 720 mm. Note that the gap I between parts of the glass tube 19 adjacent to each other in the radial directions of the arc tube 3 is set to 2.0 mm here; however, it is considered appropriate, in terms of a product, to set it in the range of 1 mm and 10 mm.

The supporting projection 65 formed on the platy member 41 of the holder has a height (“J” in FIG. 12) of 2 mm and a length (the size of the platy member 41 in the width-wide direction, and “K” of FIG. 8) of 10 mm.

4. Test Result

The following describes a tensile test of the discharge lamp of the above practical example. The tensile test was carried out with an assumption that the discharge lamp is mounted on a lamp fitting.

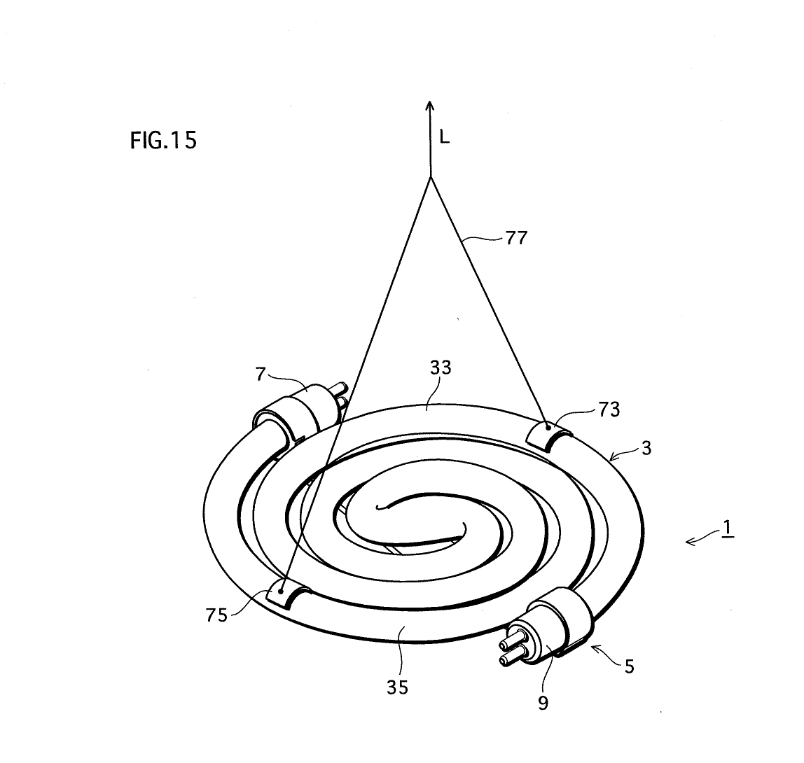

FIG. 15 is a schematic diagram of the tensile test of the discharge lamp.

In the test, as shown in FIG. 15, tensile load was applied, in the imaginary axis direction of the arc tube 3 (i.e. the direction L), to attached members 73 and 75 provided at two predetermined locations on the arc tube 3. In this way, the tensile load was applied until the attached members 73 and 75 became broken, and the breaking load was measured. The two predetermined locations to which tensile load is applied are on the outermost turns of the spiral parts 33 and 35, and are positioned at which an imaginary line perpendicular to the imaginary line connecting the two bases 7 and 9 intersects with the outermost turns of the spiral parts 33 and 35.

The tensile load was applied by pulling, in the direction L, a wire 77 attached to the attached members 73 and 75 while the bases 7 and 9 remained fixed.

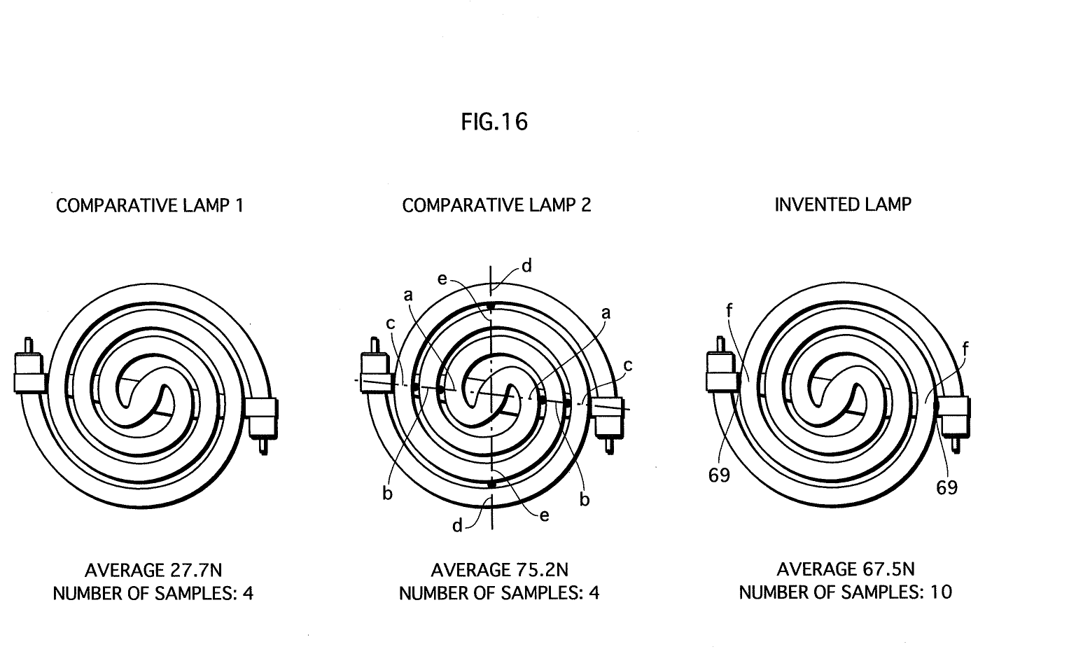

FIG. 16 shows samples used in the tensile test and the test result.

The samples used in the test are, as shown in FIG. 16, three types in total—Comparative Lamp 1, Comparative Lamp 2 and Invented Lamp.

The arc tubes and holders used for Comparative Lamps 1 and 2 and Invented Lamp are the same as the arc tube 3 and the holder 5, respectively, of the above embodiment. Note that Invented Lamp is the discharge lamp 1 described in the embodiment above.

As to difference of Invented Lamp from Comparative Lamps 1 and 2, while Comparative Lamps 1 and 2 have their bases and base adjacent parts not attached to each other, Invented Lamp has its bases and base adjacent parts attached to each other. In addition, the differences between Comparative Lamp 2 and Invented Lamp are the number of attaching points between the arc tube and the platy member and the number of attaching points of parts of the glass tube adjacent to each other in the radial directions. Note that the attachment is realized by the silicon resin 69 the same as one used to attach the bases and the arc tube.

In Comparative 1, although the arc tube and bases are attached to each other, the arc tube and the platy member are not attached to each other (i.e. the number of attaching points is zero), as shown in FIG. 16.

On the other hand, in Comparative Lamp 2 as shown in the figure, the arc tube and the bases are attached, and the number of attaching points between the arc tube and the platy member is six in total: two points each located between (i) a portion of the 1^{st} and 2^{nd} spiral parts, close to the middle part (“a” in the figure, and referred to as the “a portion”) and (ii) a portion of the glass tube, located on the outer circumference side in relation to the a-portion (“b” in the figure, and referred to as the “b-portion”); two points each located between (i) the b-portion and (ii) a portion of the glass tube, located on the outer circumference side in relation to the b-portion (“c” in the figure, and referred to as the “c-portion”); and two points each located between (i) an attaching portion of the attached member 73/75 (“d” in the figure, and referred to as the “d-portion”) and (ii) a portion of the glass tube, located on the middle part side in relation to the d-portion.

Note that the silicon resin (69) attaching the above portions of the glass tube to each other also attaches these portions of the glass tube to the platy member at the same time.

Invented Lamp includes, as shown in the figure, two fixing points each located between the base and a portion of the glass tube, adjacent to the base and located on the middle part side in relation to the base (“f” in the figure, and referred to as the “f-portion”). Here, the silicon resin (69) attaching the base and the f-portion also attaches the holder at the same time.

The test result is described below.

The number of samples for Comparative Lamp 1 was four, and the average breaking load was 27.7 N. The number of samples for Comparative Lamp 2 was four, and the average breaking load was 75.2 N. On the other hand, the number of samples of Invented Lamp was ten, and the average breaking load was 67.5 N.

Higher the breaking load, the safer the lamp is. The investigation of the inventors has found that in actual use the load of approximately 20 N is applied to where the attached members 73 and 75 are provided. Accordingly, when only the actual use is considered, it would be enough if a breaking load of 30 N is obtained in the tensile test. Accordingly, obtaining 30 N is the first object, yet 40 N or more is preferable, which is specified as the second object.

Comparative Lamp 1 cannot meet the above first object; however, Comparative Lamp 2 and Invented Lamp meet the first and second objects.

Although Comparative Lamp 2 showed the highest breaking load among the three kinds used in the test, Invented Lamp achieved about 90% of the breaking load of Comparative Lamp 2 with a smaller number of attaching points than that of Comparative Lamp 2.

This can be considered that by attaching the bases and the base adjacent parts of the arc tube, the deformation of the glass tube constituting the arc tube can be efficiently prevented even if tensile load is applied to the attaching portions.

Note that although an increase in the number of attaching points for attaching the arc tube, the holder and the like is considered to result in increasing the breaking load, if the number of attaching points increases, more steps will be required to attach the arc tube, holder and the like, which leads to an increase in cost.

On the other hand, according to Invented Lamp, the attachment of the bases 7 and 9 and the base adjacent parts (f-portions) is realized by the silicon resin 69 flowed out of the bases 7 and 9 when the bases 7 and 9 and the end parts 13 and 15 of the arc tube 3 are attached, as explained in the above manufacturing process. Unlike Comparative Lamp 2, Invented Lamp does not require a process of attaching the arc tube, holder and the like, and it yet achieves approximately 90% of the breaking load of Comparative Lamp 2. Accordingly, Invented Lamp can be realized at very reasonable cost, and furthermore can obtain 1.5 times the breaking load of the second object against the tensile load applied to where the attached members 73 and 75 are provided.

[Modifications]

The present invention has been described in accordance with the above embodiment; however, it is a matter of course that the present invention is not limited to the specific example of the embodiment. For example, the following modifications are also within the scope of the present invention.

1. Arc Tube

The arc tube of the present embodiment has a shape of a flat double spiral; however, the arc tube 3 of the present invention is not limited to the plane double spiral shape, and may have a circular cone-shaped outline as a whole, for example, when viewed from the direction perpendicular to the imaginary axis. Note that only the central side of the arc tube has a circular cone shape while outer side has a plane shape, or vice versa.

That is, the central axis of the entire glass tube constituting the spiral parts winding around the imaginary axis may lie in one plane, or may lie on a generatrix of the circular cone. Alternatively, the central axis of a part of the glass tube may lie in one plane, and the central axis of the remaining part may lie on a generatrix of the circular cone.

(1) Circular Cone-Shaped Outline

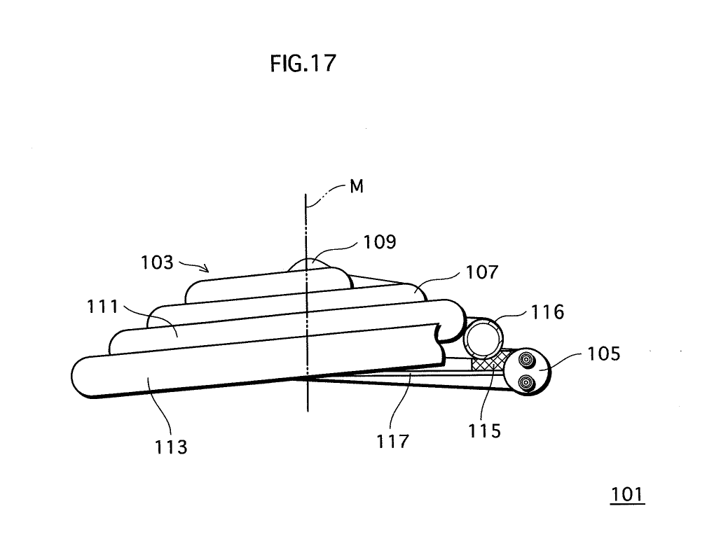

FIG. 17 is an elevation view of a discharge lamp 101 according to Modification 1, with a partial cutaway of an arc tube 103 to show details of a base 105 and its periphery with the arc tube 103.

The arc tube 103 of Modification 1 includes 1^{st} and 2^{nd} spiral parts 111 and 113. Each of the 1^{st} and 2^{nd} spiral parts 111 and 113 winds around an imaginary axis M, with a middle part 109 of a glass tube 107 lying on the imaginary axis M and the glass tube 107 winding away from the imaginary axis M at the same time moving away from the middle part 109 along the imaginary axis as shifted in the direction from the middle part 109 toward its end parts.

That is, in the arc tube 103, the central axis of the entire glass tube 107 constituting the 1^{st} and 2^{nd} spiral parts 111 and 113 lies on a generatrix of the circular cone, and the arc tube 103 has a substantially circular cone-shaped outline as a whole when viewed from the direction perpendicular to the imaginary axis M.

Onto the arc tube 103, the bases 105 and 105 are attached. Note that each base 105 has a notched part, which is a guiding part, as in the case of the bases 7 and 9 of the embodiment.

A glass tube portion 116 located adjacent to the base 105 in the direction from the base 105 toward the middle part 109 of the glass tube 107 is attached by a silicon resin 115 to the base 105, the end part of the arc tube 103 within the base 105, and a platy member 117. The silicon resin 115 is continuous with the silicon resin attaching the end part of the arc tube 103 and the base 105, and thus integrated.

In Modification 1, the base 105, the glass tube 107, and the platy member 117 correspond to the “adjacent part” of the present invention. Note that, in the present modification also, two bases 105 (only one of them is shown in the figure for the sake of simplicity) are connected by the platy member 117.

Here, parts of the discharge lamp 101 to which the bases 105 and 105 are attached (including portions to which the bases 105 are attached, and portions within the end parts of the arc tube, to which the bases 105 are not attached) correspond to the “1^{st} region” of the first present invention; and the glass tube portion 116 and a portion of the platy member 117 correspond to the “adjacent part” of the first present invention.

In addition, the glass tube portion 116 corresponds to the “adjacent parts” of the second present invention; and the base 105 corresponds to one of the “bases” of the second present invention.

Furthermore, the glass tube portion 116 corresponds to the “adjacent parts” of the third present invention; and portions of the base 105 and the platy member 117 correspond to the “end parts” or the “end-part neighboring parts” of the third present invention.

(2) End Parts of Arc Tube

Both in the above embodiment and Modification 1, the glass tube, from the middle part to the end parts, winds around the imaginary axis; however, the arc tube may have a shape in which portions of the glass tube, extending from the middle part to parts before and adjoining to the end part (referred to as the “end-part neighboring parts”), may wind around the imaginary axis while portions of the glass tube extending from the end-part neighboring parts to the end parts lie straight or are bent in a predetermined direction.

That is, in the arc tube, a portion of the glass tube, extending from the middle part to the end-part neighboring part of one or both of the end parts, may be bent so as to wind around and progressively away from the imaginary axis as shifted in the direction from the middle part toward the end-part neighboring part. Here, one or both end parts of the glass tube may extend along, for example, the imaginary axis direction, the radial direction, or the direction inclined at a predetermined angle against the imaginary axis.

In this case, the adjacent parts are those adjacent to tip parts of the spiral parts (here, corresponding to the end-part neighboring parts) winding around the imaginary axis.

(2-1) When End Parts Extend in Parallel with Imaginary Axis

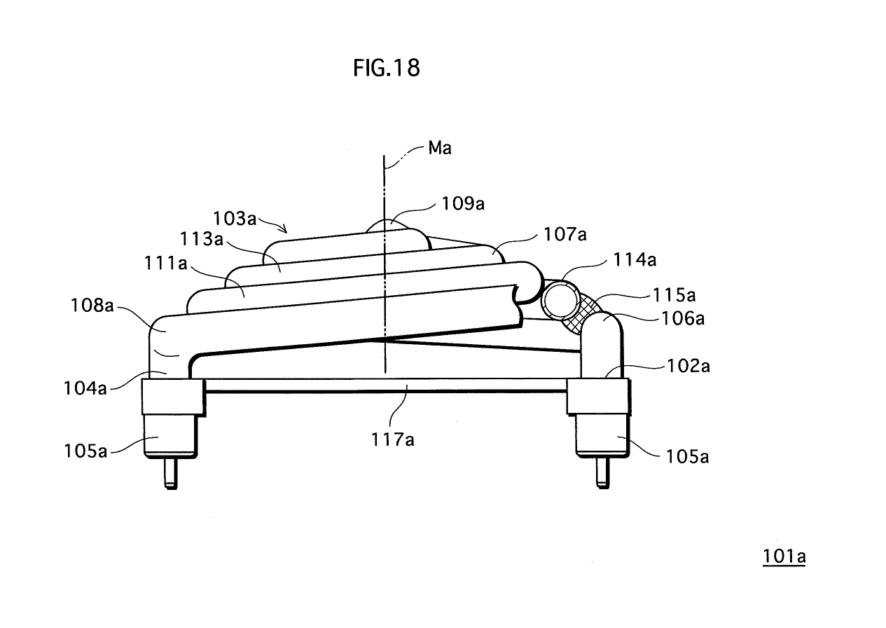

FIG. 18 is an elevation view of a discharge lamp 101a of Modification 2, with a partial cutaway of an arc tube 103a to show details of a part adjoining to the end part of the arc tube 103a (referred to as the “end-part neighboring part” 106a).

The arc tube 103a of Modification 2 includes 1^{st} and 2^{nd} spiral parts 111a and 113a. Each of the 1^{st} and 2^{nd} spiral parts 111a and 113a winds around an imaginary axis Ma, with a middle part 109a of a glass tube 107a lying on the imaginary axis Ma and the glass tube 107a winding away from the imaginary axis Ma at the same time moving away from the middle part 109 along the imaginary axis as shifted in the direction from the middle part 109a toward its end-part neighboring parts 106a and 108a.

At end parts 102a and 104a of the arc tube 103, bases 105a and 105a are attached. The bases 105a and 105a are provided on end parts of a platy member 117a, which hangs across the main plane opposite from the irradiated plane side of the arc tube 103a (precisely speaking, the 1^{st} and 2^{nd} spiral parts 111a and 113a of the arc tube).

In Modification 2, the end-part neighboring parts 106a and 108a of the glass tube 107a constituting the arc tube 103a are attached (fixed) by an adhesive agent 115a, such as a silicon resin, to adjacent parts 114a and 116a of the glass tube 107a, which are adjacent to the end-part neighboring parts 106a and 108a in the direction from the end-part neighboring parts 106a and 108a toward the middle part 109a. Note that the adjacent part 116a is not shown in the figure for the sake of simplicity.

Here, the end-part neighboring parts 106a and 108a of the glass tube 107a correspond to the “1^{st} region” of the first present invention; and the adjacent parts 114a and 116a correspond to the “adjacent part” of the first present invention.

In addition, the end-part neighboring parts 106a and 108a correspond to the “1^{st} region” of the second present invention; and the adjacent part 114a corresponds to the “adjacent parts” of the second present invention.

Furthermore, the adjacent part 114a corresponds to the “adjacent parts” of the third present invention; and the end-part neighboring part 106a corresponds to the “end-part neighboring parts” of the third present invention.

Note that in Modification 2, portions extending from the end-part neighboring parts 106a and 108a of the glass tube 107a to the ends of the glass tube 107a—i.e. end parts 102a and 104a of the glass tube 107a—are parallel with the imaginary axis Ma; however, they may lie in the direction approaching or moving away the imaginary axis Ma.

(2-2) When End Parts Extend in Direction Perpendicular to Imaginary Axis

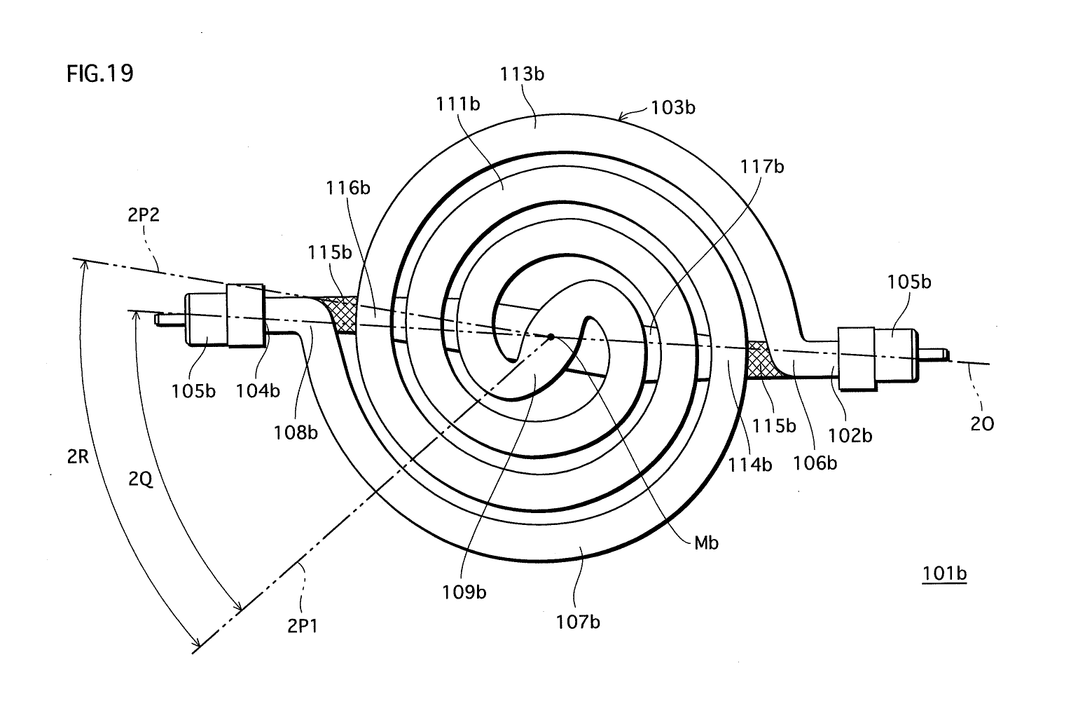

FIG. 19 is a plan view of a discharge lamp 101b of Modification 3.

An arc tube 103b of Modification 3 includes 1^{st} and 2^{nd} spiral parts 111b and 113b, each of which winds around an imaginary axis Mb, with a middle part 109b of a glass tube 107b lying on the imaginary axis Mb and the glass tube 107b winding away from the imaginary axis Mb as shifted in the direction from the middle part 109b toward its end-part neighboring parts 106b and 108b. Note that the central axis of the glass tube 107 lies in the same single plane within the 1^{st} and 2^{nd} spiral parts 111b and 113b, and also within portions extending from the end-part neighboring parts 106b and 108b of the glass tube 107b to the ends of the glass tube 107b (i.e. end parts 102b and 104b of the glass tube 107b).

At end parts 102b and 104b of the arc tube 103b, bases 105b and 105b are attached. The bases 105b and 105b are provided on end parts of a platy member 117b, which hangs across the main plane opposite from the irradiated plane side of the arc tube 103b.

In Modification 3, adjacent portions 114b and 116b of the glass tube 107b, which are adjacent to the end-part neighboring parts 106b and 108b in the direction from the end-part neighboring parts 106b and 108b towards the middle part 109b, are attached (fixed) by an adhesive agent 115b, such as a silicon resin, to the platy member 117b and the end-part neighboring parts 106b and 108b of the glass tube 107b constituting the arc tube 103b.

Here, the end-part neighboring parts 106b and 108b of the glass tube 107b correspond to the “1^{st} region” of the first present invention; and the adjacent parts 114b and 116b correspond to the “adjacent part” of the first present invention.

Furthermore, the adjacent parts 114b and 116b correspond to the “adjacent parts” of the third present invention; and the end-part neighboring parts 106b and 108b and the platy member 117b correspond to the “end-part neighboring parts” of the third present invention.

Note that in Modification 3, the end parts 102b and 104b of the glass tube 107b extend in the direction perpendicular to and away from the imaginary axis Mb; however, it may extend for example in the direction perpendicular to the imaginary axis Mb.

2. Holder

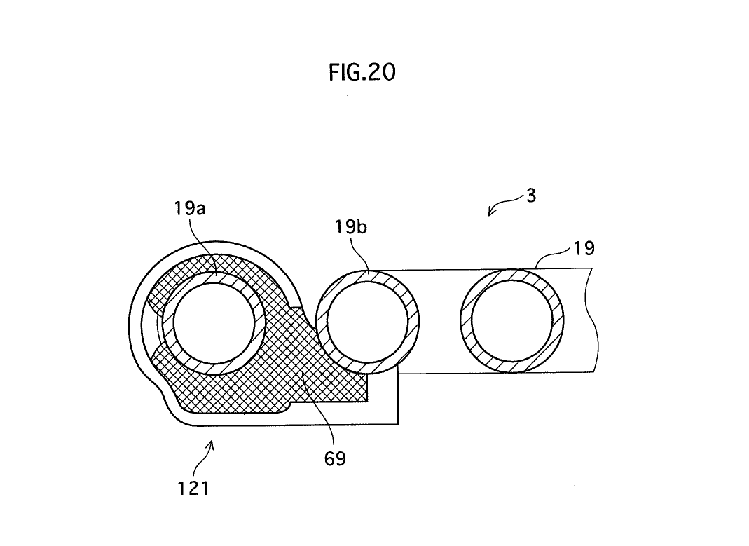

The holder 5 of the embodiment has a structure in which the two bases 7 and 9 are provided at both ends of the platy member 41; however, as Modification 4 shown in FIG. 20, a structure may be adopted instead in which two bases 121 are separately attached to glass-tube end portion 19a of the arc tube 3 (only one of the bases is shown in FIG. 20) without using a platy member, and the bases 121 and base adjacent parts 19b are attached to each other by the silicon resin 69.

Here, the glass-tube end portion 19a corresponds to the “1^{st} region” of the first present invention; and the base adjacent part 19b and the base 121 correspond to the “adjacent part” of the first present invention.

In addition, the base adjacent part 19b corresponds to one of the “adjacent parts” of the second present invention; and the base 121 corresponds to one of the “bases” of the second present invention.

Furthermore, the base adjacent part 19b corresponds to one of the “adjacent parts” of the third present invention; and the glass-tube end portion 19a and the base 121 correspond to the “end parts” or the “end-part neighboring parts” of the third present invention.

In this case, the bases may or may not have the supporting projection 65 and connecting projection 67 provided on the platy member.

In the embodiment, the bases 7 and 9 have the fitting parts 43 and 45 and base parts 47 and 49. However, the holder of the present invention may be composed of, for example, the two fitting parts 43 and 45 of the embodiment and a connecting member of these fitting parts 43 and 45 (corresponding to the platy member 41 of the embodiment) without the base parts 47 and 49, and a base (corresponding to the base part of the embodiment), which is a component separate from the holder, may be attached to a fitting part of the holder.

3. Base

(1) Types

In the embodiment, the base is a so-called G-type; however, a different type, such as a GX-type, GY-type, or a P-type, may be used. Note that if the operability of attaching and detaching the discharge lamp to/from a lamp fitting is considered, the base preferably has pins.

In the embodiment, the direction in which two pins of the base lie is substantially parallel to the direction of the imaginary axis D, as shown in FIG. 4. This is in order to narrow the width (i.e. a size in the direction perpendicular to the imaginary axis) of a lamp fitting's socket which is electrically connected to the pins.

However, as shown in FIG. 4, the direction in which two pins lie is set at an angle of no greater than 45° (within the range of 0° and 45° (“N” in FIG. 4)) against an imaginary line D1 parallel to the imaginary axis D. Accordingly, the incidence can be eliminated in which the socket comes into contact with the glass tube adjacent to the base when the discharge lamp is attached to the lamp fitting, and also allows the socket to be compact.

(2) Structure

In the embodiment, the base includes the fitting part and the base part. However, if for example the internal circumference of the base-part main body of the base part is large and the end part of the arc tube can be inserted directly into the base-part main body, a fitting part can be integrated in the base-part main body.

Furthermore, the fitting part in the embodiment includes two cylinder parts; however, needless to say, it may include only one cylinder part, or three or more cylinder parts.

(3) Guiding Part (Notched Part)

The guiding part is, as described above, for guiding the adhesive agent inside the base to the outside when the base and the arc tube are attached by the adhesive agent, and its shape, size and the like are not particularly limited.

Specifically speaking, the guiding part may be a through-hole formed on the peripheral wall of the base (corresponding to the fitting part). In this case, the shape of the through-hole is not particularly limited, and maybe a circle, ellipse, oval, or square. The size may be determined case by case in view of the attachment area of the base and base adjacent part, the distance between the base and the base adjacent part and the like.

Note that when the guiding part is formed by the notched part, the shape of the notch is also not particularly limited, and the notch may be a circle, ellipse, oval, or a part of a polygon. The size may be determined case by case in view of the attachment area of the base and base adjacent part, the distance between the base and the base adjacent part and the like.

In view of the tensile load exerted on the arc tube when the discharge lamp is attached or detached, if an end-part neighboring portion of the discharge lamp and a glass-tube adjacent part, which adjoins to the end-part neighboring portion in the radial direction around the imaginary axis of the arc tube as a center, are attached to each other directly, or indirectly via the base, it is possible to make the arc tube less likely to be broken against the tensile load.

Accordingly, the base of the present invention does not have to include a guiding part.

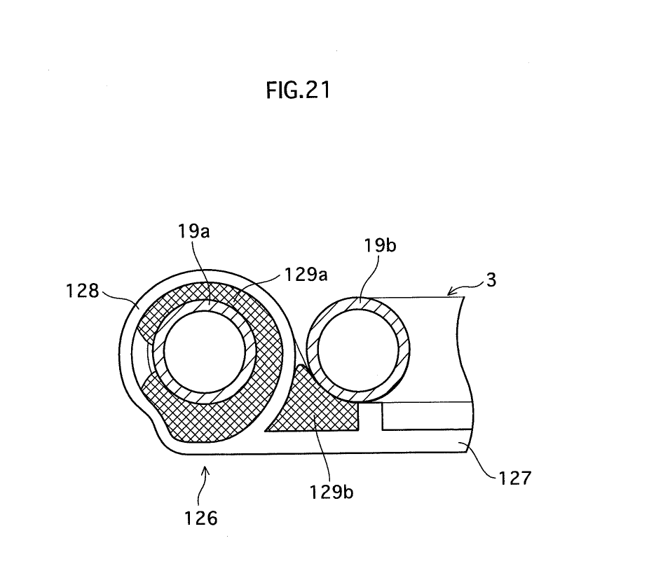

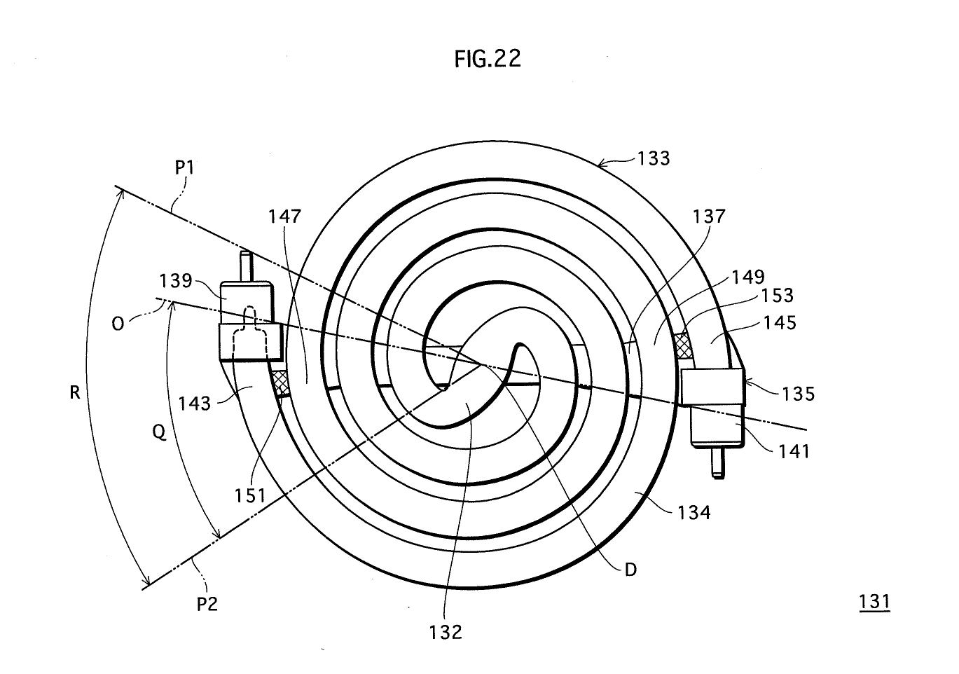

FIG. 21 shows a base according to Modification 5.

As shown in the figure, a holder 126 includes two bases 128 (one base is not shown in the figure) provided on a single platy member 127. Each of the bases 128 is attached by an adhesive agent (silicon resin) 129a to the glass-tube end portion 19a in the end part of the arc tube 3, which is inserted inside of the base 128.

The base adjacent part 19b adjacent to the base 128 in the radial direction is attached by an adhesive agent (silicon resin) 129b directly to the outer circumference of the base 128, which is located between the glass-tube end portion 19a and the base adjacent part 19b. Note that the glass-tube adjacent portion 19b is also attached to the platy member 127 by a adhesive agent 129b.

Here, the glass-tube end portion 19b corresponds to the “1^{st} region” of the first present invention; and the base 128 and a portion of the platy member 127 correspond to the “adjacent part” of the first present invention.

In addition, the base adjacent part 19b corresponds to one of the “adjacent parts” of the second present invention; and the base 128 corresponds to one of the “bases” of the second present invention.

Furthermore, the base adjacent part 19b corresponds to one of the “adjacent parts” of the third present invention; and the base 128 and the platy member 127 correspond to the “end parts” or the “end-part neighboring parts” of the third present invention.

In FIG. 21, the bases 128 are connected to the platy member 127; however, the bases 128 not connected by the platy member 127 (i.e. the bases are cylindrical) may be attached to the end parts of the arc tube 3. In this case, the base adjacent part 19b is directly attached (fixed) to the bases 128 by an adhesive agent.

Here, the glass-tube end portion 19b corresponds to the “1^{st} region” of the first present invention; and the base 128 corresponds to the “adjacent part” of the first present invention.

In addition, the base adjacent part 19b corresponds to one of the “adjacent parts” of the second present invention; and the base 128 corresponds to one of the “bases” of the second present invention.

Furthermore, the base adjacent part 19b corresponds to one of the “adjacent parts” of the third present invention; and the base 128 corresponds to one of the “end parts” or one of the “end-part neighboring parts” of the third present invention.

(4) Restraint Part

In the embodiment, the restraint part is formed by multiple ribs; however, it may be formed by, for example, multiple projections protruding from the internal surface of the base.

4. Fixation

(1) Fixation Material

In the embodiment and the like, an adhesive agent, such as a silicon resin, is used as the fixation material. It is considered that the arc tube would be less likely to be broken if deformation of the arc tube can be prevented when tensile load is applied to the arc tube during the time when the discharge lamp is being attached or detached,

From this stand point, it can be considered that, instead of attaching by an adhesive agent, fixing by the fixation material a glass tube portion, which adjoins to the end-part neighboring portion in the radial direction around the imaginary axis of the arc tube as a center, realizes the same effect. Specifically speaking, a restraint arm (hook) may be provided on the base so as to restrain the irradiating plane side of a glass tube portion, which is adjacent to the glass-tube end part in the direction perpendicular to the imaginary axis, to thereby fix the glass tube portion.

(2) Fixing Position

In the embodiment, the base and the base adjacent part of the arc tube are attached to each other by an adhesive agent. However, it can be considered that the tensile strength described in the above embodiment can be obtained also when, for example, end-part neighboring portions 143 and 145 of a discharge lamp 131 are attached by an adhesive agent to glass tube adjacent parts 147 and 149 adjacent to the end-part neighboring portions 143 and 145 in radial directions thereof, as shown in Modification 6 of FIG. 22.

The lamp 131 of Modification 6 includes an arc tube 133 and a holder 135. The holder 135 is formed with two bases 139 and 141 provided on a platy member 137. Note that the bases 139 and 141 are G-type as in the case of the embodiment.

In Modification 6, glass-tube adjacent parts 147 and 149, which are adjacent, in radial directions around the imaginary axis D as a center, to portions corresponding to end parts of the glass tube 134—i.e. the end-part neighboring portions 143 and 145—are attached to the end-part neighboring portions 143 and 145 and the platy member 137 by adhesive agent 151 and 153.

That is, the end-part neighboring portions 143 and 145 of the glass tube 107b correspond to the “1^{st} region” of the first present invention; and the glass tube adjacent parts 147 and 149 and a portion of the platy member 137 correspond to the “adjacent part” of the first present invention.

Furthermore, the glass tube adjacent parts 147 and 149 correspond to the “adjacent parts” of the third present invention; and the end-part neighboring portions 143 and 145 and the platy member 137 correspond to the “end parts” or the “end-part neighboring parts” of the third present invention.

Here, it can be considered that an aimed breaking load can be obtained when tensile load is applied if each of the glass-tube adjacent parts 147 and 149, which are the end-part neighboring portions of the discharge lamp, is positioned within the range between (i) the end of the discharge lamp 131 (the tip of the pin) and (ii) a location shifted by 45°, along the spiral part around the imaginary axis D as a center, from the edge of the base 139/141 on the opening side toward a middle part 132 of the arc tube 133. The range is, in the other words, a range R between imaginary lines P1 and P2 around the imaginary axis.

Note that the imaginary line P1 is a line connecting the imaginary axis D and an end of the spiral part, located in the spiraling direction, within the arc tube 133 of the discharge lamp 131. The imaginary line P2 is, in a plan view, a line connecting (i) the imaginary axis D and (ii) a location shifted by 45° (“Q” in FIG. 22) around the imaginary axis D, toward the middle part 132 from an imaginary line O connecting approximately the middle of each of the bases 139 and 141 (the imaginary line O runs through the imaginary axis D).

The range R above is applied to the case where portion of the glass tube 134 including up to its end parts winds around the imaginary axis D, as shown in FIG. 22. However, the same can be applied to the case where portion of the glass tube up to the end-part neighboring parts winds around the imaginary axis.

The range for the case where portion of the glass tube up to the end-part neighboring parts winds around the imaginary axis is explained next with the aid of FIG. 19.

It can be considered that an aimed breaking load can be obtained when tensile load is applied if each of the end-part neighboring portions of the discharge lamp 101b is located within 2R between imaginary lines 2P1 and 2P2 ranging around an imaginary axis Mb.

The imaginary line 2P2 is a line connecting the imaginary axis Mb and an end of the spiral part (111b/113b), located in the spiraling direction, within the arc tube 103b of the discharge lamp 101b. The imaginary line 2P1 is, in a plan view, a line connecting (i) the imaginary axis Mb and (ii) a location shifted by 45° (“2Q” in FIG. 19) around the imaginary axis Mb, toward the middle part 109b from an imaginary line 20 connecting approximately the middle of each of the bases 105b and 105b (the imaginary line 20 runs through the imaginary axis Mb).

The above remarks can be summarized as follows: each of the end-part neighboring portions of the discharge lamp is, when the discharge lamp (101b) is viewed in a plan view, set within the range between (i) a location positioned in the spiraling direction of the arc tube (103b) of the discharge lamp (101b) and furthest from the middle part (109b) and (ii) a location shifted by 45°, along the spiral part (111b/113b) around the imaginary axis (Mb) as a center, from the imaginary line (20) connecting approximately the middle of each of paired bases (105b and 105b) toward the middle part (109b) of the arc tube (103b).

Note that the middle of the base coincides with approximately the middle of the spiral part of the arc tube in the spiraling direction.

In addition, the end-part neighboring portions described in the embodiment and modifications are only required to be in the range R above. Part within the range R may be fixed with glass-tube adjacent parts which are adjacent, when viewed in a plan view, to the part of the range R on the inward side in radial direction (This is the case in the embodiment and modifications). Or the entire range R may be fixed to a glass-tube adjacent portion adjacent to the range R in radial direction. Alternatively, multiple points within the range R may be fixed with a glass-tube adjacent part adjacent to the range R.

(3) Predetermined Portion

In the embodiment and modifications above, predetermined portions to which glass-tube adjacent parts adjacent to the end-part neighboring portions of the discharge lamp are fixed are the bases, or the end-part neighboring portions of the discharge lamp; however, they may be other portions. Note that portions where the adjacent parts are fixed to the predetermined portions are portions, within the predetermined portions, facing the adjacent parts.

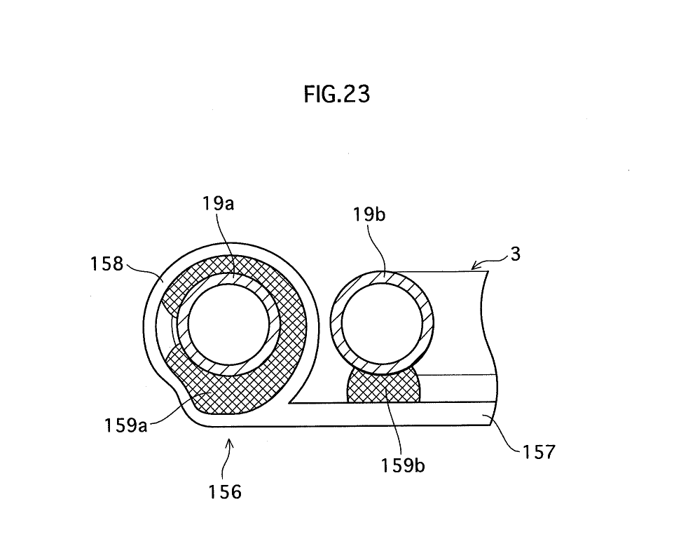

FIG. 23 shows part of a discharge lamp according to Modification 7.

As shown in the figure, a holder 156 includes two bases 158 (one base is not shown in the figure) provided on a single platy member 157. Each of the bases 158 is attached by an adhesive agent 159a with the glass-tube end portion 19a in the end part of the arc tube 3, which is inserted inside of the base 158.

The glass-tube adjacent parts 19b adjacent, in radial directions, to the bases 158 corresponding to the glass-tube end portion 19a are attached to the platy member 157 by an adhesive agent (silicon resin) 159b.

That is, the glass-tube end portion 19a corresponds to the “1^{st} region” of the first present invention; and a portion of the platy member 157 corresponds to the “adjacent part” of the first present invention.

Furthermore, the glass-tube end portion 19a corresponds to one of the “adjacent parts” of the third present invention; and the platy member 157 corresponds to the “end parts” or the “end-part neighboring parts” of the third present invention.

4. Other Particular

In the embodiment and modifications above, no particular explanations are given for combinations of the embodiment and modifications. However, part of the embodiment and part of each modification may be combined.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A discharge lamp comprising:
an arc tube (i) which includes a glass tube and electrodes each sealed in at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is;
a holder supporting the arc tube; and
two bases supplying power to the electrodes,
wherein a 1^{st} region is within the portion of the glass tube,
an adjacent part including one or more of the holder, the bases, and a 2^{nd} region positioned within the glass tube is disposed adjacent to the 1^{st} region, and
the 1^{st} region is fixed to the adjacent part by a fixation material.

2. The discharge lamp of claim 1, wherein
a tube central axis of the portion of the glass tube lies in one plane.

3. The discharge lamp of claim 1, wherein
the adjacent part includes at least one of the 2^{nd} region and a portion of the bases.

4. The discharge lamp of claim 3, wherein
the arc tube has a disk-shaped outline, and one main surface of the arc tube is an irradiating surface side,
the holder includes a platy member hanging across another main plane of the arc tube, opposite from the irradiating surface side,
the bases are disposed on the platy member, and
the adjacent part includes a portion of the platy member.

5. The discharge lamp of claim 3, wherein
the fixation material is an adhesive agent,
the 1^{st} region is the one end part of the glass tube, and
the adjacent part is the portion of the bases.

6. The discharge lamp of claim 4, wherein
the fixation material is an adhesive agent,
the 1^{st} region is the end parts of the glass, and
the adjacent part is the portion of the platy member.

7. The discharge lamp of claim 3, wherein
the bases oppose each other across the imaginary axis, and
the 1^{st} region is part or all of a range between (i) each end of the discharge lamp and (ii) a location shifted by 45°, around the imaginary axis along the glass tube, toward the middle part from a substantially central portion of each of the bases when viewed in a plan view.

8. The discharge lamp of claim 6, wherein
the bases oppose each other across the imaginary axis, and
the 1^{st} region is part or all of a range between (i) each end of the discharge lamp and (ii) a location shifted by 45°, around the imaginary axis along the glass tube, toward the middle part from a substantially central portion of each of the bases when viewed in a plan view.

9. The discharge lamp of claim 3, wherein
at least one of the bases includes a pair of pins both lying in one plane, and
when viewed in a protruding direction of the pins, the plane lies at an angle of no greater than 45° against the imaginary axis.

10. The discharge lamp of claim 8, wherein
each of the bases includes a pair of pins both lying in one plane, and
when viewed in a protruding direction of the pins, the plane lies at an angle of no greater than 45° against the imaginary axis.

11. The discharge lamp of claim 3, wherein
the arc tube has a shape of a double spiral.

12. The discharge lamp of claim 10, wherein
the arc tube has a shape of a double spiral.

13. A discharge lamp comprising:
an arc tube (i) which includes a glass tube and electrodes each sealed in at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is; and
two bases attached onto the end parts of the glass tube and supplying power to the electrodes,
wherein adjacent parts within the glass tube, each of which is adjacent to one of the bases, are fixed at least to the bases by a fixation material.

14. A discharge lamp comprising:
an arc tube (i) which includes a glass tube and electrodes each disposed at one of two end parts of the glass tube, and (ii) in which a portion of the glass tube, extending from a middle part of the glass tube to one of at least one end part and at least one end-part neighboring part thereof, winds around an imaginary axis and progressively away from the imaginary axis as shifted in a direction from the middle part toward the one of at least one end part and at least one end-part neighboring part, the end-part neighboring part adjoining to the end part and being, along the direction, closer to the middle part than the end part is; and
a holder supporting the arc tube,
wherein adjacent parts within the glass tube, each of which is adjacent to one of the end parts of the glass tube, or one of end-part neighboring parts of the glass tube, are fixed to the end parts or the end-part neighboring parts by a fixation material.
